(19) United States
(12) Patent Application Publication
(10) Pub. No.: US 2023/0115093 A1
(43) Pub. Date: Apr. 13, 2023

(54) MACHINE-LEARNED MODELS FOR PREDICTING DATABASE SIZE

(71) Applicant: SAP SE, Walldorf (DE)

(72) Inventor: Deng Zhou, Neckargemund (DE)

(21) Appl. No.: 17/499,678

(22) Filed: Oct. 12, 2021

(51) Int. Cl. G06N 5/04; G06N 5/02; G06F 16/25; G06F 16/11

(52) U.S. Cl. CPC G06N 5/04; G06N 5/022; G06F 16/256; G06F 16/113

(57) ABSTRACT

In an example embodiment, machine learned models are trained and used to predict a size of a database. These machine learned models are able to utilize a snapshot of the database to first predict a correlation between the sizes of a top N number of application tables in the database and the size of the database as a whole, and then predict a size for the top N number of application tables. These predictions may then be combined to derive a prediction of the size of the database.

### BACKGROUND

Enterprise Resource Planning (ERP) software integrates into a single system various processes used to run an organization, such as finance, manufacturing, human resources, supply chain, services, procurement, and others. These processes typically provide intelligence, visibility, and efficiency across most if not all aspects of an organization. One Example of ERP software is SAP® S/4 HANA from SAP SE of Walldorf, Germany.

ERP software is typically made up of multiple applications that share a single database.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating an ERP system, in accordance with an example embodiment.

FIG. 2 is a diagram illustrating an in-memory database management system, including its client/external connection points, which can be kept stable in the case of disaster recovery to ensure stable service operations, in accordance with an example embodiment.

FIG. 3 is a block diagram illustrating a Data Volume Management (DVM) application, in accordance with an example embodiment.

FIG. 4 is a block diagram illustrating a database size prediction component in more detail, in accordance with an example embodiment.

FIG. 5 is a block diagram illustrating a table size prediction component in more detail, in accordance with an example embodiment.

FIG. 6 is a diagram illustrating an example histogram, in accordance with an example embodiment.

FIG. 7 is a block diagram illustrating an ERP software database size prediction component in more detail, in accordance with an example embodiment.

FIG. 8 is a flow diagram illustrating a method of using machine learned models to predict a size of an ERP software database, in accordance with an example embodiment.

FIG. 9 is a flow diagram illustrating a method of training a second machine learned model, in accordance with an example embodiment.

FIG. 10 is a block diagram illustrating a software architecture, which can be installed on any one or more of the devices described above.

FIG. 11 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

In an example embodiment, machine learned models are trained and used to predict a size of an Enterprise Resource Planning (ERP) software database. These machine learned models are able to utilize a snapshot of the ERP software database to first predict a correlation between the sizes of a top N number of application tables in the ERP software database and the size of the ERP software database as a whole, and then predict a size for the top N number of application tables. These predictions may then be combined to derive a prediction of the size of the ERP software database.

It should be noted that “top” in this context refers to the application tables that are the largest in size in the database. Thus, if N is 10, then the top 10 largest application tables in the database are used for these calculations.

A distinction is made between an application table, which is a table that is written to by an application program, and a system table, which is a table that is not written to by an application program (but is written to, for example, by the database management software and may be used to aid in the management of the application tables). This distinction is relevant because system tables typically do not change in size significantly, and thus are not predictive of a growth trend for a database.

The predicted size of an ERP software database can be used in a number of different ways. In a typical ERP software database, the size of the database increases as new records are generated. Users are also able to perform archiving activities to archive the records out of the application tables to reduce the size of the database. The prediction of the size of the database over time can be useful, therefore, in recommending how urgently the user needs to begin archiving operations, or whether they need to change their current archiving and/or new record addition behavior in the near future to avoid having the database grow beyond a certain size, such as a size beyond which database performance will suffer or storage space becomes unreasonably expensive, or if it is simply challenging technologically to add additional memory to the database. Thus, for example, it would be useful to predict after how many months the database will be “full” if the user keeps their ERP software database (and corresponding archiving or data reduction operations) performing as-is.

As briefly described earlier, this solution is able to utilize a snapshot of the ERP software database to perform the necessary predictions using the machine-learned models. This is in contrast to, for example, gathering statistical data over time, which can take months or years to obtain enough statistical data to perform an accurate prediction using machine-learned models. As such, the present solution has technical benefits over prior art machine-learned models trained to perform the same task, in that the present solution does not require waiting for statistical data to be generated over time but instead can be used with just a single database snapshot at one point in time.

It should be noted that the single database snapshot still does contain information collected over some period of time, such as the last few days or weeks, but this is still significantly different than needing to wait months or years to make predictions for upcoming months.

In an example embodiment, the following data may be collected from the ERP software database snapshot:
1. Historical database size over the last few days/weeks, from available local database statistics
2. Historical table size for the top N application tables over the last few days/weeks, from available local database statistics
3. Time distribution of new records (e.g., histogram) for each of the top N application tables
4. Historical archiving activities
5. Mapping between tables and archiving objects

It should be known that N is a parameter that may be set either automatically or by an administrator to tune the machine learned models in the present solution. When set by an administrator, the value may be set empirically. When set automatically, a separate machine learned model may be trained and used to learn the value of N based at least partially on feedback from previous predictions of the main machine learned model. For example, the main machine learned models may be predict that an ERP software database will be full in 6 months if the user does not change their pattern of adding new records and/or archiving. If that prediction turns out to be inaccurate, and the database fills up after only 3 months of the same user behavior, then this information may be fed into the separate machine learned model, which may alter its value of N to improve prediction reliability (it should also be noted that the main machine learned models can also be retrained using this “bad performance” information as well, as it is possible that it was not the value of N that was the issue but the value of one of the weights learned by the main machine learned models, as will be discussed in more detail below.)

In an example embodiment, the ERP software database is an in-memory database, such as HANA® from SAP SE of Walldorf, Germany. An in-memory database (also known as an in-memory database management system) is a type of database management system that primarily relies on main memory for computer data storage. It is contrasted with database management systems that employ a disk storage mechanism. In-memory databases are traditionally faster than disk storage databases because disk access is slower than memory access.

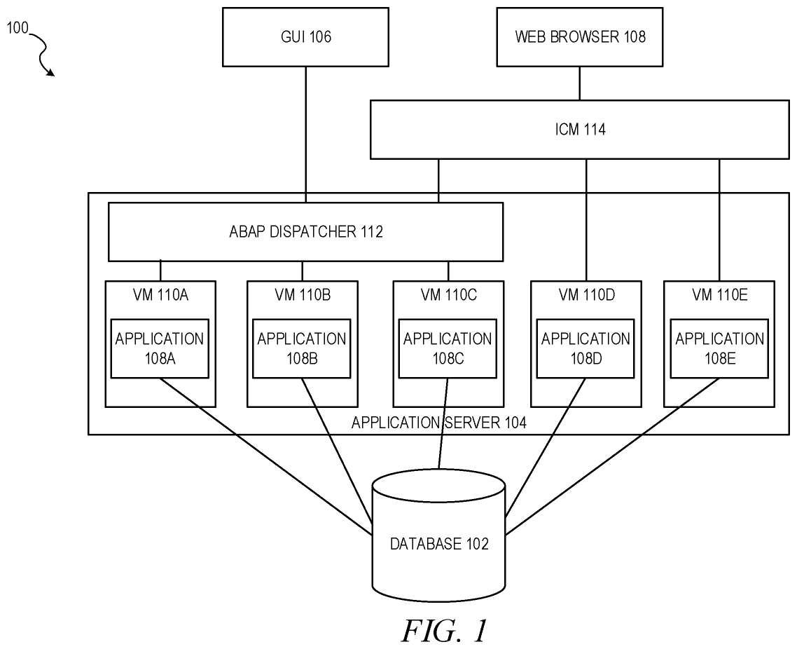

FIG. 1 is a block diagram illustrating an ERP system 100, in accordance with an example embodiment. The ERP system 100 may include a database 102, an application server 104, a graphical user interface (GUI) 106 and a web browser 108. The GUI 106 and the web browser 108 are alternative ways for a user to communicate with the application server 104. The database 102 and application server 104 may be located on one or more servers in a cloud environment.

The application server 104 includes one or more ERP applications 108A-108E. Here, the applications 108A-108E each run on their own virtual machine 110A-110E, and may be accessed using commands in Advanced Business Application Programming (ABAP) language, via an ABAP dispatcher 112, or using commands in Java from an Internet Communication Manager (ICM) 114. Notably, all of the applications 108A-108E access the same database 102, which has a size. It is this size that the machine learned models of the present solution will attempt to predict.

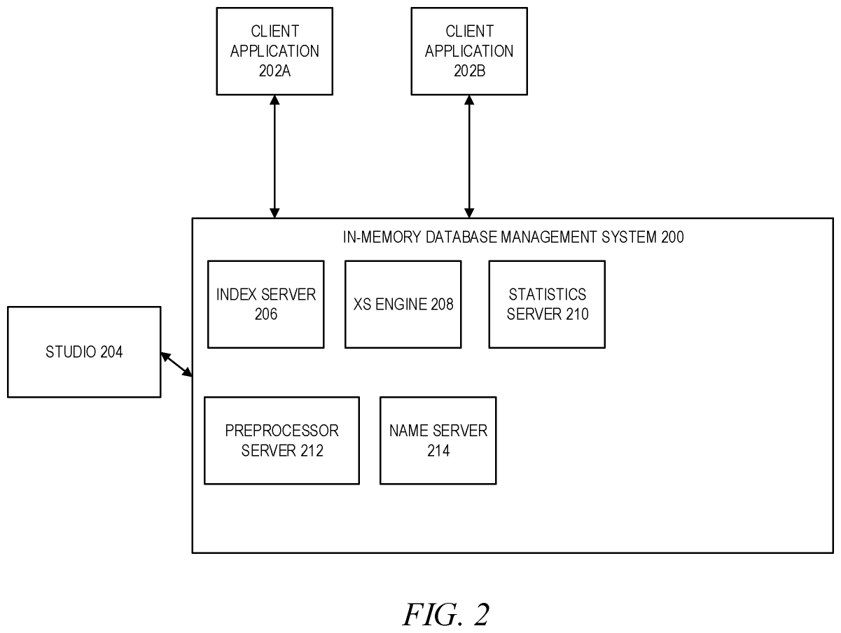

In some example embodiments the database 102 is an in-memory database. FIG. 2 is a diagram illustrating an in-memory database management system 200, including its client/external connection points, which can be kept stable in the case of disaster recovery to ensure stable service operations, in accordance with an example embodiment. It should be noted that one of ordinary skill in the art will recognize that sometimes an in-memory database management system 200 is also referred to as an in-memory database. Here, the in-memory database management system 200 may be coupled to one or more client applications 202A, 202B. The client applications 202A, 202B may communicate with the in-memory database management system 200 through a number of different protocols, including Structured Query Language (SQL), Multidimensional Expressions (MDX), Hypertext Transfer Protocol (HTTP), REST, and Hypertext Markup Language (HTML).

Also depicted is a studio 204, used to perform modeling or basic database access and operations management by accessing the in-memory database management system 200.

The in-memory database management system 200 may comprise a number of different components, including an index server 206, an XS engine 208, a statistics server 210, a preprocessor server 212, and a name server 214. These components may operate on a single computing device, or may be spread among multiple computing devices (e.g., separate servers).

The index server 206 contains the actual data and the engines for processing the data. It also coordinates and uses all the other servers.

The XS engine 208 allows clients to connect to the in-memory database management system 200 using web protocols, such as HTTP.

The statistics server 210 collects information about status, performance, and resource consumption from all the other server components. The statistics server 210 can be accessed from the studio 204 to obtain the status of various alert monitors.

The preprocessor server 212 is used for analyzing text data and extracting the information on which text search capabilities are based.

The name server 214 holds information about the database topology. This is used in a distributed system with instances of the database on different hosts. The name server 214 knows where the components are running and which data is located on which server.

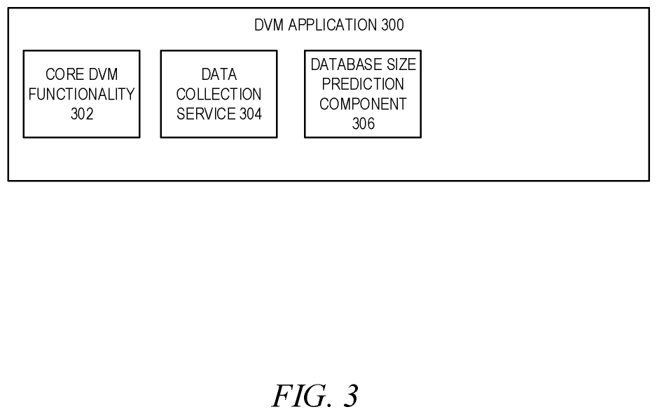

Referring back to FIG. 1, one of the applications 108A-108E is a DVM application. FIG. 3 is a block diagram illustrating a DVM application 300, in accordance with an example embodiment. DVM application 300 may include core DVM functionality 302, which includes software modules for performing various typical DVM operations, such as monitoring database and/or table growth, monitoring executed archiving activities, trending to predict future growth and/or size, recommending suitable actions to system administrators or database operators. Also included is a data collection service 304, which in this context acts to perform a data collection operation on the snapshot of the database 102 to create or calculate the time distribution of new records (e.g., histogram). More particularly, the data collection service 304 searches the database 102 to identify time stamps on when new records were added to the top N application tables, and organizes this information into a time series. For example, a histogram may be defined with monthly buckets (e.g., each bucket is one month), and the timestamps can be used to determine which buckets to assign a new record that was created for one of the top N application tables. Ultimately, therefore, the histogram will indicate how many records were added to the top N application tables for each month. Notably, this timestamp information, while describing past events, is stored in the snapshot of the current database 102 and thus is not something that requires waiting to gather information on. This timestamp information may be stored in, for example, in application 108A, every document (record) stored in database 102 has timestamp field, to represent the creation date/time of the document (record). ADK provides a method for archiving data in the database 102

The mapping between tables and archiving objects and the historical archiving activities may also be stored in such ADK tables and retrieved using the data collection service 304.

A database size prediction component 306 may then act to predict the size of the database 102 over time, assuming current trends, based on the time distribution of new records from the data collection service 304 and the other information mentioned previously. In an example embodiment, the historical database size over the last few days/weeks and the historical table size for the top N application tables over the last few days/weeks can be obtained from the statistics server 210 of FIG. 2, with the other information retrieved from the data collection service 304 as described above.

As discussed briefly earlier, the database size prediction component 306 may utilize multiple machine learned models to make its prediction of the database size. The prediction may be in the form of multiple predictions, one for each of a predetermined time period in the future. For example, the database size prediction component 306 may be designed to output a predicted database size for each month of the next 24 months.

The prediction is made at the time period-level (e.g., month, day, etc.) as opposed to a specific time because the granularity of the training data may also be at the same time period-level and not at a specific time. For example, data may only be collected and grouped monthly, and thus more specific predictions (e.g., hourly) may not be possible, although in some sense all times are themselves time periods of smaller time intervals, and as such the term “time period” shall not be construed as indefinite in any way as it still refers to a specific grouping of time, at whatever granularity.

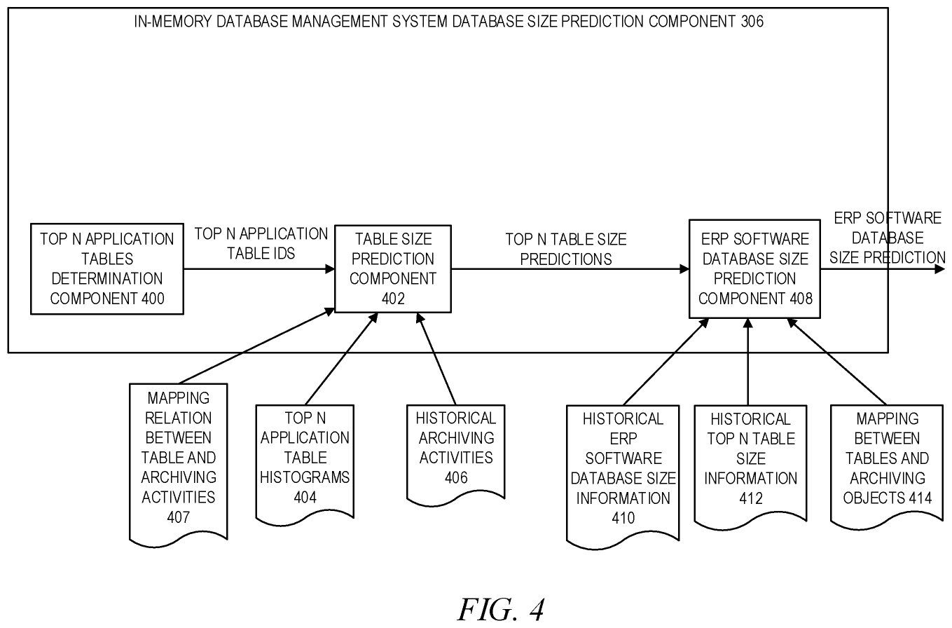

FIG. 4 is a block diagram illustrating a database size prediction component 306 in more detail, in accordance with an example embodiment. A top N application tables determination component 400 acts to determine the top N application tables in the ERP software database, based on table size. The top N application tables determination component 400 then sends an identification of each of these tables to a table size prediction component 402. The table size prediction component 402 uses one or more machine learned models to predict the size of a table corresponding to each table identification it is passed. In an example embodiment, this prediction may be in the form of a prediction of the number of records in the corresponding table for each of one or more time periods in the future (e.g., for each month of the next 24 months). Thus, if it is passed identifications for tables A, B, and C, then it will output separate predictions for tables A, B, and C. The predictions may be based on top N application table histograms 404 and historical archiving activities 406 and a mapping relation between table and archiving activities 407.

The top N application table size predictions are then passed to an ERP software database size prediction component 408, which may use one or more machine learned models to predict a total ERP software database size for each of one or more future time periods (e.g., each month for the next 24 months). This may be based on the predictions from table size prediction component 402 and also on historical ERP software database size information 410 (from the statistics server), historical top N table size information 412 (also from the statistics server), and the mapping between tables and archiving objects (from the data collection service).

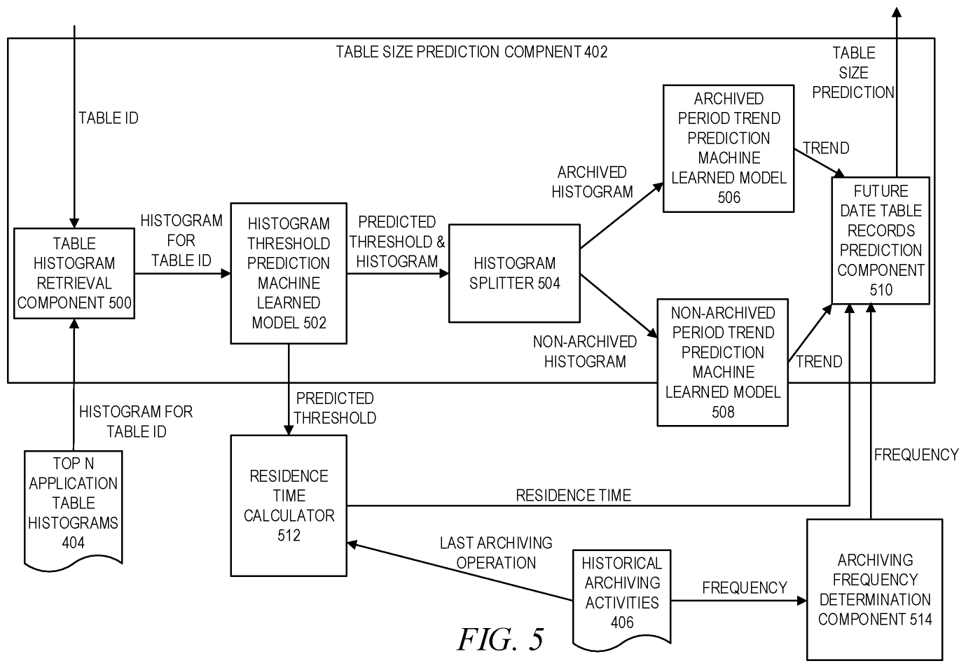

FIG. 5 is a block diagram illustrating a table size prediction component 402 in more detail, in accordance with an example embodiment. As mentioned above, this table size prediction component 402 takes a table identification as input and outputs a prediction of the size of the table at one or more future time periods. A table histogram retrieval component 500 thus acts to retrieve a corresponding histogram indicating number of records for a table corresponding to a received table identification. This histogram is then passed to a histogram threshold prediction machine learned model 502, which acts to predict a time threshold between records that were archived and records that were not archived. In other words, the histogram threshold prediction machine learned model 502 may attempt to identify a time point in the histogram after which the records were likely not archived but whose records prior to which were likely archived, all from looking at the histogram itself.

In an example embodiment, the histogram threshold prediction machine learned model 502 uses both a k-means machine learned model and a logistic regression machine learned model together to make the prediction of the threshold. The k-means machine learned model is a clustering model that takes data points as input and groups them into k clusters. The process of grouping is the training phase, and results in a model that takes a data sample as input and returns the cluster that the new data point belongs to. Logistic regression uses a logistic function to perform classification. Here, the independent variables in the classification are continuous and the dependent variables are in categorical form (such as classes).

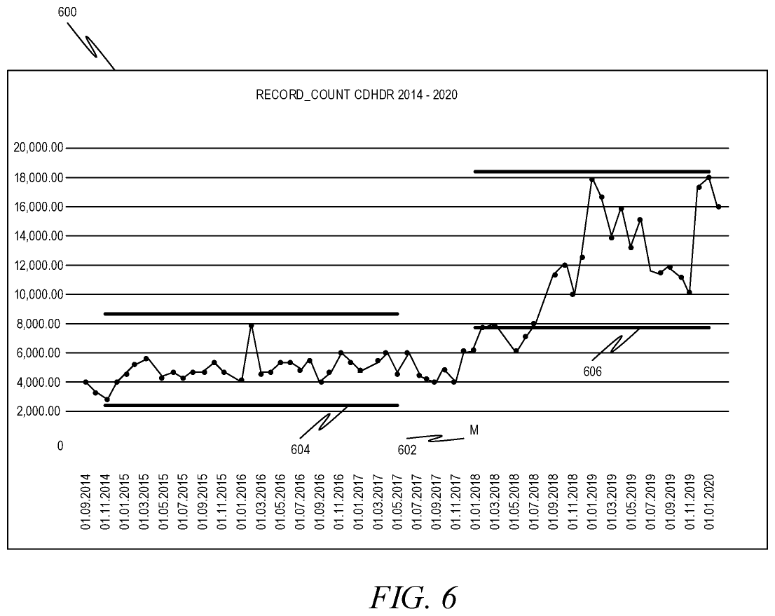

FIG. 6 is a diagram illustrating an example histogram 600, in accordance with an example embodiment. Here, a histogram threshold prediction machine learned model 502 has predicted a particular threshold 602. As can be seen, it appears that the graph of record counts has followed a first trend line 604 prior to the threshold 602 and a second, different trend line 606 after the threshold 602, which is likely what the histogram threshold prediction machine learned model 502 has detected, thus making the threshold prediction based on the change in the trend lines 604, 606.

Thus, in an example embodiment, the combination of the k-means machine learned model and the logistic regression machine learned model are trained to identify shifts in trend lines in a histogram to identify a threshold at which the trend lines changed.

Referring back to FIG. 5, the output of the histogram threshold prediction machine learned model 502 is a predicted threshold. This predicted threshold is then input to a histogram splitter 504, which acts to split the histogram for the table corresponding to the input table identification into two: an archived period histogram (including all data prior to the threshold) and a non-archived period histogram (including all data subsequent to the threshold). An archived period trend prediction machine learned model 506 then acts to predict a trend for record size for the corresponding table for the archived time period, while a non-archived period trend prediction machine learned model 508 then predicts a trend for record size for the corresponding table for the non-archived time period. These trends are then input as parameters to a future date table records prediction component 510, which acts to use these trends to predict future table size at one or more later time periods. It should be noted that the future date table records prediction component 510 is not limited to using just the trends in this prediction. Indeed, two additional pieces of information (residence time and frequency of archiving run) are also input to the future date table records prediction component 510.

Each of the archived period trend prediction machine learned model 506 and the non-archived period trend prediction machine learned model 508 may comprise one or more separate trained machine learned models for predicting their corresponding trends. In an example embodiment, each have two machine learned models: a linear/polynomial regression model, and an AutoRegressive Integrated Moving Average (ARIMA) mode. ARIMA is a class of model that captures a suite of different standard temporal structures in time series data. In an example embodiment, the ARIMA model may include non-seasonal models and/or seasonal models (e.g., to model time series data with seasonal fluctuations). A non-seasonal ARIMA model is typically expressed in the form of ARIMA (p, d, q), where p denotes the order of the autoregressive model, d denotes the order of differencing (e.g., number of non-seasonal differences), and q denotes the order of moving-average terms. A seasonal ARIMA model is typically expressed in the form of ARIMA (p, d, q)*(P, D, Q) s, where P denotes the number of seasonal autoregressive terms, D denotes the number of seasonal differences, Q denotes the number of seasonal moving-average terms, and s denotes the number of periods per season. Both non-seasonal and seasonal models may include a constant.

For residence time, the threshold predicted by the histogram threshold prediction machine learned model 502 is passed to a residence time calculator 512, which determines the difference between a date of a most recent archiving run (from the historical archiving activities 406) and the predicted threshold, and this difference is the residence time.

For frequency of archiving runs, a preset frequency time period is used as input to an archiving frequency determination component 514. The preset frequency time period is a value indicating how far back in time should be examined to determine archiving frequency (for example, 12 months, or 24 months). The archiving frequency determination component 514 then determines the frequency of archiving that was performed during that time period, from the historical archiving activities 406.

Thus, the future date table records prediction component 510 is then able to compute the table size in records for each of one or more future dates, by assuming a continuation of the trends output by the archived period trend prediction machine learned model 506 and the non-archived period trend prediction machine learned model 508, assuming a residence time equal to the residence time output by the residence time calculator 512 and a frequency of archiving output by the archiving frequency determination component 514.

It should be noted that the architecture of FIG. 5 is used when the corresponding table has had at least one successful archiving run. If instead the table has never been archived, the entire architecture need not be used as there would be no archived period. As such, the non-archived period trend prediction machine learned model 508 may be used alone to predict the trend and the future date table records prediction component 510 may simply use this trend alone to predict the table size for future time periods.

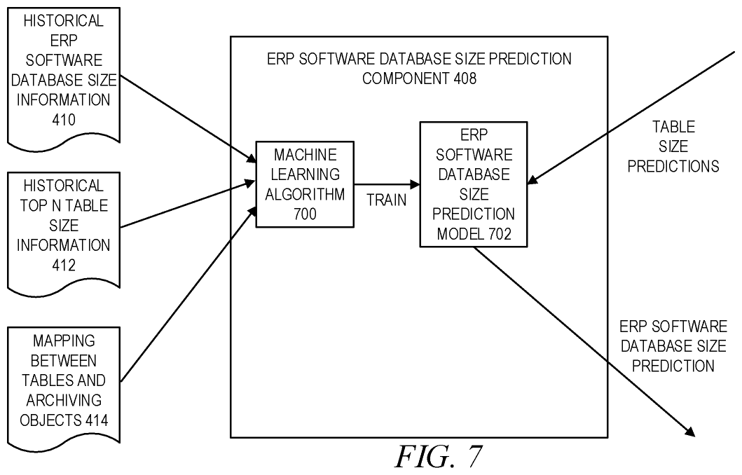

FIG. 7 is a block diagram illustrating an ERP software database size prediction component 408 in more detail, in accordance with an example embodiment. Here, historical ERP software database size information 410 (from the statistics server) and historical top N table size information 412 (also from the statistics server) are fed to a machine learning algorithm 700 to train a ERP software database size prediction model 702 to predict the ERP software database size at one or more future time periods, based on the predictions from the table size prediction component 402 for each of the top N application tables. Here, the training involves learning a weight that is assigned to the prediction for each of the top N application tables, and the ERP software database size prediction model 702 then multiplies the predictions for each corresponding application table by the appropriate learned weight. Each weight is essentially a constant that is learned through the machine learning process. The machine learning algorithm 700 modifies the weights, and then evaluates a corresponding loss function, repeating the process until the corresponding loss function outputs a loss value that is minimized. In other words, it repeats its calculations over and over, with minor changes to the weights each iteration, until the loss is minimized, at which point it stops iterating and outputs the last value for each weight as the learned weights. It should be noted that this training may be repeated at a later time, using additional inputs (such as different historical ERP software database size information 410 (from the statistics server) and historical top N table size information 412, or based on user feedback, essentially retraining the weights.

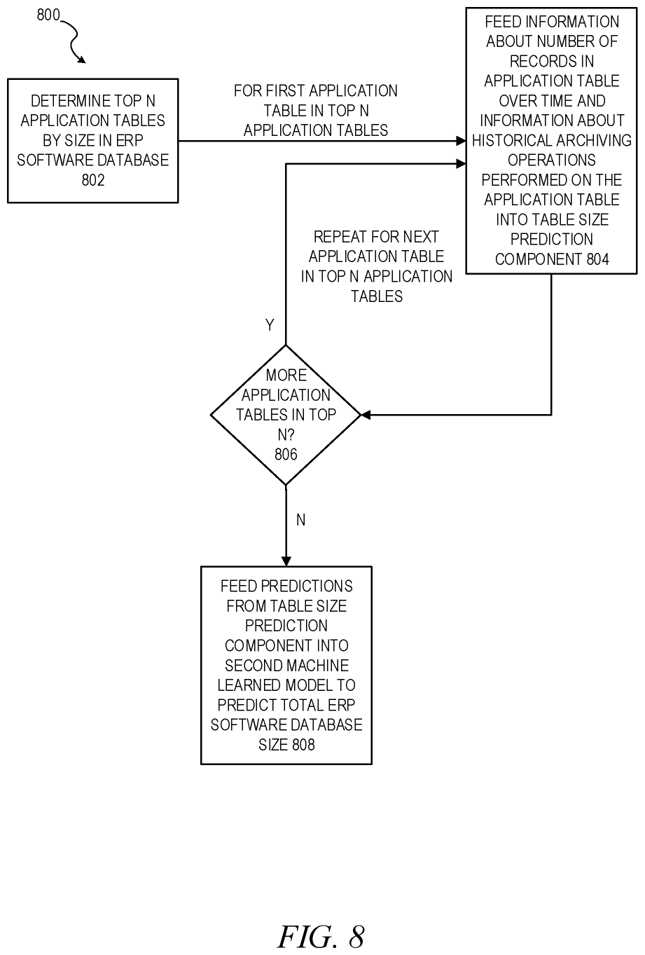

FIG. 8 is a flow diagram illustrating a method 800 of using machine learned models to predict a size of an ERP software database, in accordance with an example embodiment. At operation 802, a top N application tables by size in an Enterprise Resource Planning (ERP) software database are determined. N is an integer and may be set or learned by its own machine learned model. Then, a loop begins for each of the top N application tables by size. At operation 804, information about the number of records in the application table over time (histogram) and information about historical archiving operations performed on the application table are fed into a table size prediction component that utilizes a first machine learned model. The first machine learned model makes a prediction of a size for the application table at a future time period. At operation 806, it is determined if there are any additional application tables in the top N application tables by size. If so, then the method 800 loops back to operation 804 for the next application table in the top N application tables by size.

If not, then at operation 808, the predictions from the table size prediction component are fed into a second machine learned model, the second machine learned model having been trained using a machine learning algorithm to predict a total ERP software database size at future time period.

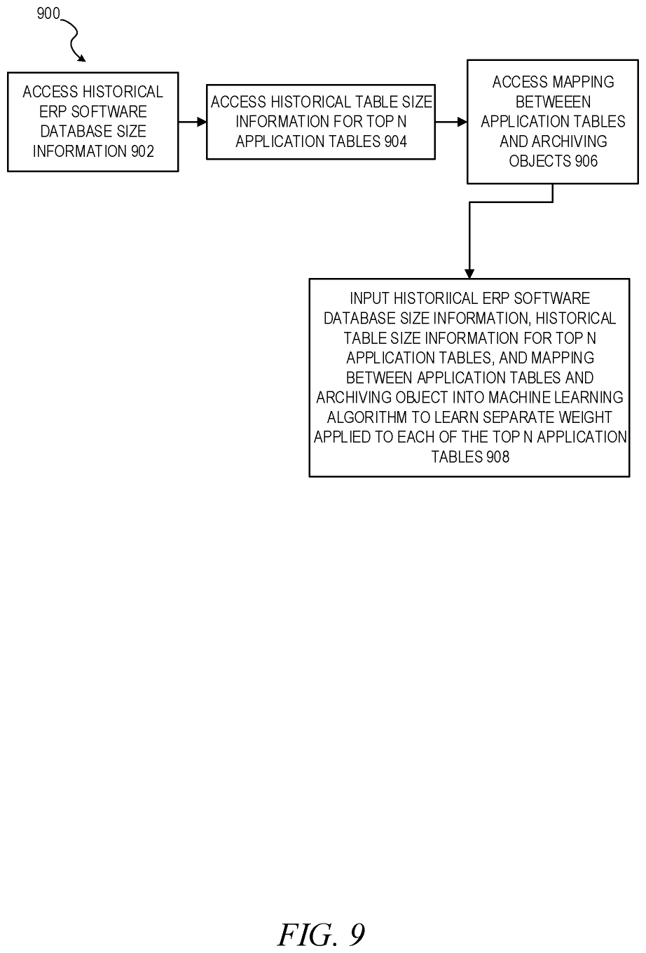

FIG. 9 is a flow diagram illustrating a method 900 of training a second machine learned model, in accordance with an example embodiment. The second machine learned model is the one utilized by operation 808 of FIG. 8.

At operation 902, historical ERP software database size information is accessed. At operation 904, historical table size information for the top N application tables is accessed. At operation 906, a mapping between application tables and archiving objects is accessed. At operation 908, the historical ERP software database size information, the historical table size information for the top N application tables, and the mapping between application tables and archiving objects are input into a machine learning algorithm, causing the machine leaning algorithm to learn a separate weight applied to each of the top N application tables based on the inputs. The predicted total ERP software database size can then be computed by operation 808 of FIG. 8 by summing products calculated by multiplying the predicted application table size for each of the top N application tables by its corresponding learned weight.

In view of the above-described implementations of subject matter, this application discloses the following list of examples, wherein one feature of an example in isolation or more than one feature of said example taken in combination and, optionally, in combination with one or more features of one or more further examples are further examples also falling within the disclosure of this application:

Example 1. A system comprising:

at least one hardware processor; and
a computer-readable medium storing instructions that, when executed by the at least one hardware processor, cause the at least one hardware processor to perform operations comprising:

identifying N application tables, in a software database, that have a larger size than the remainder of the application tables in the database, wherein N is an integer;

for each of the N application tables:
feeding information about a number of records over time in the application table and information about historical archiving operations performed on the application table into a table size prediction component that utilizes a first machine learned model, the first machine learned model making a prediction of a size for the application table at a future time period; and

feeding the N predictions from the table size prediction component into a second machine learned model, the second machine learned model having been trained using a machine learning algorithm to predict a total size for the database at the future time period, the training including inputting historical database size information, historical table size information for the N application tables, and a mapping between the N application tables and archiving objects into a machine learning algorithm, and the machine leaning algorithm learning a separate weight applied to each of the N application tables based on the inputs, the predicted total database size computed by summing products calculated by multiplying the predicted application table size for each of the N application tables by its corresponding learned weight.

Example 2. The system of Example 1, wherein the information about the number of records in the application table over time is a histogram and the table size prediction component comprises a histogram threshold prediction machine learned model that predicts a time point in the histogram at which a trend of a record size for the corresponding application table changes.

Example 3. The system of Example 2, wherein the histogram threshold prediction machine learned model is combination of a k-means and a logistic regression model.

Example 4. The system of Examples 2 or 3, wherein the table size prediction component further comprises an archived period trend prediction machine learned model that takes a first portion of the histogram for time periods prior to the predicted threshold and outputs a first trend, and a non-archived period trend prediction machine learned model that takes a second portion of the histogram for time periods after the predicted threshold and outputs a second trend.

Example 5. The system of Example 4, wherein the first trend and the second trend are input to a future date table records prediction component, which uses the first trend and the second trend along with a residence time and a frequency to predict a table size.

Example 6. The system of Example 5, wherein the residence time is calculated by subtracting the predicted threshold from a time period of a last archiving operation performed on the corresponding table.

Example 7. The system of any of Examples 4-6, wherein the archived period trend prediction machine learned model utilizes an AutoRegressive Integrated Moving Average (ARIMA) model.

Example 8. A method comprising:
identifying N application tables, in a software database, that have a larger size than the remainder of the application tables in the database, wherein N is an integer;
for each of the N application tables:
   feeding information about a number of records over time in the application table and information about historical archiving operations performed on the application table into a table size prediction component that utilizes a first machine learned model, the first machine learned model making a prediction of a size for the application table at a future time period; and
feeding the N predictions from the table size prediction component into a second machine learned model, the second machine learned model having been trained using a machine learning algorithm to predict a total size for the database at the future time period, the training including inputting historical database size information, historical table size information for the N application tables, and a mapping between the N application tables and archiving objects into a machine learning algorithm, and the machine leaning algorithm learning a separate weight applied to each of the N application tables based on the inputs, the predicted total database size computed by summing products calculated by multiplying the predicted application table size for each of the N application tables by its corresponding learned weight.

Example 9. The method of Example 8, wherein the information about the number of records in the application table over time is a histogram and the table size prediction component comprises a histogram threshold prediction machine learned model that predicts a time point in the histogram at which a trend of a record size for the corresponding application table changes.

Example 10. The method of Example 9, wherein the histogram threshold prediction machine learned model is combination of a k-means and a logistic regression model.

Example 11. The method of Examples 9 or 10, wherein the table size prediction component further comprises an archived period trend prediction machine learned model that takes a first portion of the histogram for time periods prior to the predicted threshold and outputs a first trend, and a non-archived period trend prediction machine learned model that takes a second portion of the histogram for time periods after the predicted threshold and outputs a second trend.

Example 12. The method of Example 11, wherein the first trend and the second trend are input to a future date table records prediction component, which uses the first trend and the second trend along with a residence time and a frequency to predict a table size.

Example 13. The method of Example 12, wherein the residence time is calculated by subtracting the predicted threshold from a time period of a last archiving operation performed on the corresponding table.

Example 14. The method of any of Examples 11-13, wherein the archived period trend prediction machine learned model utilizes an AutoRegressive Integrated Moving Average (ARIMA) model.

Example 15. A non-transitory machine-readable medium storing instructions which, when executed by one or more processors, cause the one or more processors to perform operations comprising:

identifying N application tables, in a software database, that have a larger size than the remainder of the application tables in the database, wherein N is an integer;

for each of the N application tables:
feeding information about a number of records over time in the application table and information about historical archiving operations performed on the application table into a table size prediction component that utilizes a first machine learned model, the first machine learned model making a prediction of a size for the application table at a future time period; and

feeding the N predictions from the table size prediction component into a second machine learned model, the second machine learned model having been trained using a machine learning algorithm to predict a total size for the database at the future time period, the training including inputting historical database size information, historical table size information for the N application tables, and a mapping between the N application tables and archiving objects into a machine learning algorithm, and the machine leaning algorithm learning a separate weight applied to each of the N application tables based on the inputs, the predicted total database size computed by summing products calculated by multiplying the predicted application table size for each of the N application tables by its corresponding learned weight.

Example 16. The non-transitory machine-readable medium of Example 15, wherein the information about the number of records in the application table over time is a histogram and the table size prediction component comprises a histogram threshold prediction machine learned model that predicts a time point in the histogram at which a trend of a record size for the corresponding application table changes.

Example 17. The non-transitory machine-readable medium of Example 16, wherein the histogram threshold prediction machine learned model is combination of a k-means and a logistic regression model.

Example 18. The non-transitory machine-readable medium of Examples 16 or 17, wherein the table size prediction component further comprises an archived period trend prediction machine learned model that takes a first portion of the histogram for time periods prior to the predicted threshold and outputs a first trend, and a non-archived period trend prediction machine learned model that takes a second portion of the histogram for time periods after the predicted threshold and outputs a second trend.

Example 19. The non-transitory machine-readable medium of Example 18, wherein the first trend and the second trend are input to a future date table records prediction component, which uses the first trend and the second trend along with a residence time and a frequency to predict a table size.

Example 20. The non-transitory machine-readable medium of Example 19, wherein the residence time is calculated by subtracting the predicted threshold from a time period of a last archiving operation performed on the corresponding table.

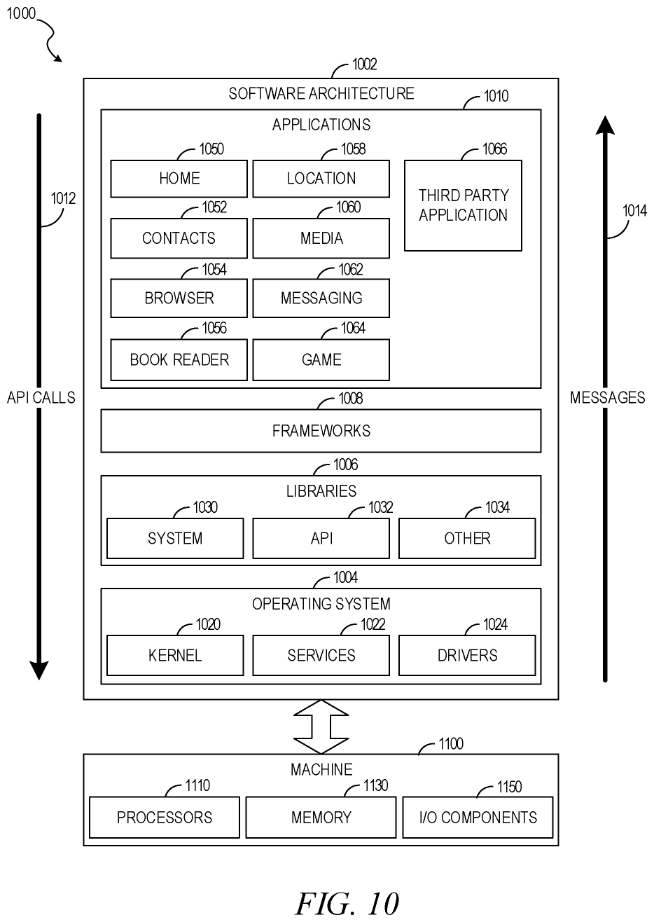

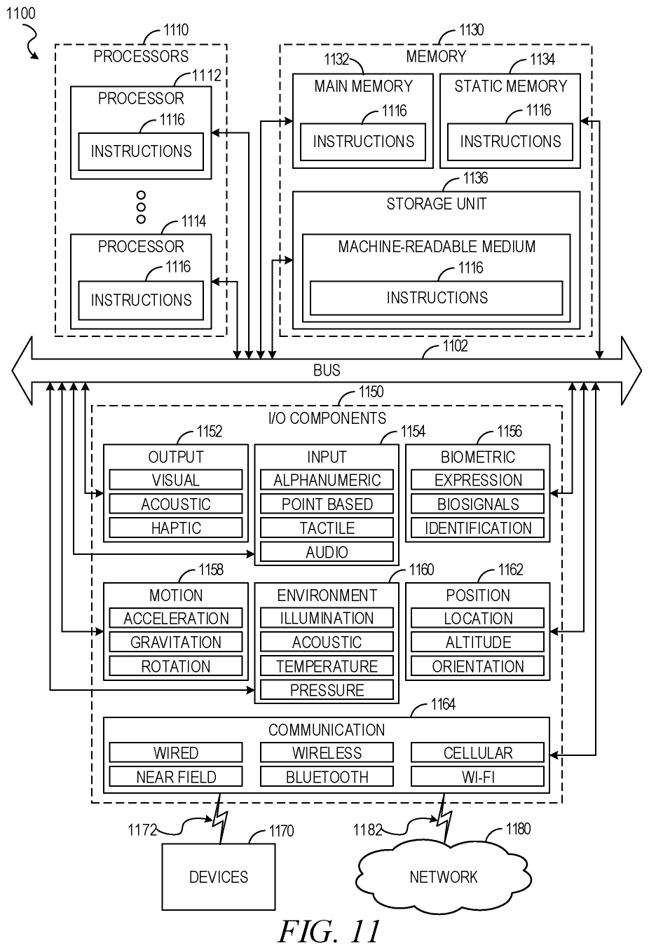

FIG. 10 is a block diagram 1000 illustrating a software architecture 1002, which can be installed on any one or more of the devices described above. FIG. 10 is merely a non-limiting example of a software architecture, and it will be appreciated that many other architectures can be implemented to facilitate the functionality described herein. In various embodiments, the software architecture 1002 is implemented by hardware such as a machine 1100 of FIG. 11 that includes processors 1110, memory 1130, and input/output (I/O) components 1150. In this example architecture, the software architecture 1002 can be conceptualized as a stack of layers where each layer may provide a particular functionality. For example, the software architecture 1002 includes layers such as an operating system 1004, libraries 1006, frameworks 1008, and applications 1010. Operationally, the applications 1010 invoke Application Program Interface (API) calls 1012 through the software stack and receive messages 1014 in response to the API calls 1012, consistent with some embodiments.

In various implementations, the operating system 1004 manages hardware resources and provides common services. The operating system 1004 includes, for example, a kernel 1020, services 1022, and drivers 1024. The kernel 1020 acts as an abstraction layer between the hardware and the other software layers, consistent with some embodiments. For example, the kernel 1020 provides memory management, processor management (e.g., scheduling), component management, networking, and security settings, among other functionality. The services 1022 can provide other common services for the other software layers. The drivers 1024 are responsible for controlling or interfacing with the underlying hardware. For instance, the drivers 1024 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 1006 provide a low-level common infrastructure utilized by the applications 1010. The libraries 1006 can include system libraries 1030 (e.g., C standard library) that can provide functions such as memory allocation functions, string manipulation functions, mathematic functions, and the like. In addition, the libraries 1006 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 1006 can also include a wide variety of other libraries 1034 to provide many other APIs to the applications 1010.

The frameworks 1008 provide a high-level common infrastructure that can be utilized by the applications 1010. For example, the frameworks 1008 provide various graphical user interface (GUI) functions, high-level resource management, high-level location services, and so forth. The frameworks 1008 can provide a broad spectrum of other APIs that can be utilized by the applications 1010, some of which may be specific to a particular operating system 1004 or platform.

In an example embodiment, the applications 1010 include a home application 1050, a contacts application 1052, a browser application 1054, a book reader application 1056, a location application 1058, a media application 1060, a messaging application 1062, a game application 1064, and a broad assortment of other applications, such as a third-party application 1066. The applications 1010 are programs that execute functions defined in the programs. Various programming languages can be employed to create one or more of the applications 1010, structured in a variety of manners, such as object-oriented programming languages (e.g., Objective-C, Java, or C++) or procedural programming languages (e.g., C or assembly language). In a specific example, the third-party application 1066 (e.g., an application developed using the ANDROID™ or IOS™ software development kit (SDK) by an entity other than the vendor of the particular platform) may be mobile software running on a mobile operating system such as IOS™, ANDROID™ WINDOWS® Phone, or another mobile operating system. In this example, the third-party application 1066 can invoke the API calls 1012 provided by the operating system 1004 to facilitate functionality described herein.

FIG. 11 illustrates a diagrammatic representation of a machine 1100 in the form of a computer system within which a set of instructions may be executed for causing the machine 1100 to perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute the methods of FIGS. 8 and 9. Additionally, or alternatively, the instructions 1116 may implement FIGS. 1-9 and so forth. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions 1116 contemporaneously. Although FIG. 11 shows multiple processors 1110, the machine 1100 may include a single processor 1112 with a single core, a single processor 1112 with multiple cores (e.g., a multi-core processor 1112), multiple processors 1112, 1114 with a single core, multiple processors 1112, 1114 with multiple cores, or any combination thereof.

The memory 1130 may include a main memory 1132, a static memory 1134, and a storage unit 1136, each accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion, and the grouping is in no way limiting. In various example embodiments, the I/O components 1150 may include output components 1152 and input components 1154. The output components 1152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162, among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., coupled via a USB).

Moreover, the communication components 1164 may detect identifiers or include components operable to detect identifiers. For example, the communication components 1164 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

The various memories (i.e., 1130, 1132, 1134, and/or memory of the processor(s) 1110) and/or the storage unit 1136 may store one or more sets of instructions 1116 and data structures (e.g., software) embodying or utilized by any one or more of the methodologies or functions described herein. These instructions (e.g., the instructions 1116), when executed by the processor(s) 1110, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1180 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., Hypertext Transfer Protocol (HTTP)). Similarly, the instructions 1116 may be transmitted or received using a transmission medium via the coupling 1172 (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1116 for execution by the machine 1100, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
identifying N application tables, in a software database, that have a larger size than the remainder of the application tables in the database, wherein N is an integer;
for each of the N application tables:
feeding information about a number of records over time in the application table and information about historical archiving operations performed on the application table into a table size prediction component that utilizes a first machine learned model, the first machine learned model making a prediction of a size for the application table at a future time period; and
feeding the N predictions from the table size prediction component into a second machine learned model, the second machine learned model having been trained using a machine learning algorithm to predict a total size for the database at the future time period, the training including inputting historical database size information, historical table size information for the N application tables, and a mapping between the N application tables and archiving objects into a machine learning algorithm, and the machine leaning algorithm learning a separate weight applied to each of the N application tables based on the inputs, the predicted total database size computed by summing products calculated by multiplying the predicted application table size for each of the N application tables by its corresponding learned weight.

2. The system of claim 1, wherein the information about the number of records in the application table over time is a histogram and the table size prediction component comprises a histogram threshold prediction machine learned model that predicts a time point in the histogram at which a trend of a record size for the corresponding application table changes.

3. The system of claim 2, wherein the histogram threshold prediction machine learned model is combination of a k-means and a logistic regression model.

4. The system of claim 2, wherein the table size prediction component further comprises an archived period trend prediction machine learned model that takes a first portion of the histogram for time periods prior to the predicted threshold and outputs a first trend, and a non-archived period trend prediction machine learned model that takes a second portion of the histogram for time periods after the predicted threshold and outputs a second trend.

5. The system of claim 4, wherein the first trend and the second trend are input to a future date table records prediction component, which uses the first trend and the second trend along with a residence time and a frequency to predict a table size.

6. The system of claim 5, wherein the residence time is calculated by subtracting the predicted threshold from a time period of a last archiving operation performed on the corresponding table.

7. The system of claim 4, wherein the archived period trend prediction machine learned model utilizes an AutoRegressive Integrated Moving Average (ARIMA) model.

8. A method comprising:
identifying N application tables, in a software database, that have a larger size than the remainder of the application tables in the database, wherein N is an integer;
for each of the N application tables:
feeding information about a number of records over time in the application table and information about historical archiving operations performed on the application table into a table size prediction component that utilizes a first machine learned model, the first machine learned model making a prediction of a size for the application table at a future time period; and
feeding the N predictions from the table size prediction component into a second machine learned model, the second machine learned model having been trained using a machine learning algorithm to predict a total size for the database at the future time period, the training including inputting historical database size information, historical table size information for the N application tables, and a mapping between the N application tables and archiving objects into a machine learning algorithm, and the machine leaning algorithm learning a separate weight applied to each of the N application tables based on the inputs, the predicted total database size computed by summing products calculated by multiplying the predicted application table size for each of the N application tables by its corresponding learned weight.

9. The method of claim 8, wherein the information about the number of records in the application table over time is a histogram and the table size prediction component comprises a histogram threshold prediction machine learned model that predicts a time point in the histogram at which a trend of a record size for the corresponding application table changes.

10. The method of claim 9, wherein the histogram threshold prediction machine learned model is combination of a k-means and a logistic regression model.

11. The method of claim 9, wherein the table size prediction component further comprises an archived period trend prediction machine learned model that takes a first portion of the histogram for time periods prior to the predicted threshold and outputs a first trend, and a non-archived period trend prediction machine learned model that takes a second portion of the histogram for time periods after the predicted threshold and outputs a second trend.

12. The method of claim 11, wherein the first trend and the second trend are input to a future date table records prediction component, which uses the first trend and the second trend along with a residence time and a frequency to predict a table size.

13. The method of claim 12, wherein the residence time is calculated by subtracting the predicted threshold from a time period of a last archiving operation performed on the corresponding table.

14. The method of claim 11, wherein the archived period trend prediction machine learned model utilizes an AutoRegressive Integrated Moving Average (ARIMA) model.

15. A non-transitory machine-readable medium storing instructions which, when executed by one or more processors, cause the one or more processors to perform operations comprising:
identifying N application tables, in a software database, that have a larger size than the remainder of the application tables in the database, wherein N is an integer;
for each of the N application tables:
feeding information about a number of records over time in the application table and information about historical archiving operations performed on the application table into a table size prediction component that utilizes a first machine learned model, the first machine learned model making a prediction of a size for the application table at a future time period; and
feeding the N predictions from the table size prediction component into a second machine learned model, the second machine learned model having been trained using a machine learning algorithm to predict a total size for the database at the future time period, the training including inputting historical database size information, historical table size information for the N application tables, and a mapping between the N application tables and archiving objects into a machine learning algorithm, and the machine leaning algorithm learning a separate weight applied to each of the N application tables based on the inputs, the predicted total database size computed by summing products calculated by multiplying the predicted application table size for each of the N application tables by its corresponding learned weight.

16. The non-transitory machine-readable medium of claim 15, wherein the information about the number of records in the application table over time is a histogram and the table size prediction component comprises a histogram threshold prediction machine learned model that predicts a time point in the histogram at which a trend of a record size for the corresponding application table changes.

17. The non-transitory machine-readable medium of claim 16, wherein the histogram threshold prediction machine learned model is combination of a k-means and a logistic regression model.

18. The non-transitory machine-readable medium of claim 16, wherein the table size prediction component further comprises an archived period trend prediction machine learned model that takes a first portion of the histogram for time periods prior to the predicted threshold and outputs a first trend, and a non-archived period trend prediction machine learned model that takes a second portion of the histogram for time periods after the predicted threshold and outputs a second trend.

19. The non-transitory machine-readable medium of claim 18, wherein the first trend and the second trend are input to a future date table records prediction component, which uses the first trend and the second trend along with a residence time and a frequency to predict a table size.

20. The non-transitory machine-readable medium of claim 19, wherein the residence time is calculated by subtracting the predicted threshold from a time period of a last archiving operation performed on the corresponding table.
